(19) United States
(12) Patent Application Publication
(10) Pub. No.: US 2012/0323826 A1
(43) Pub. Date: Dec. 20, 2012

(54) System and Method for Predicting Political Instability using Bayesian Networks

(75) Inventors: Krzysztof W. Przytula, Santa Monica, CA (US); Rashmi N. Sundareswara, Los Angeles, CA (US); Steven B. Seida, Wylie, TX (US)

(73) Assignee: RAYTHEON COMPANY, Waltham, MA (US)

(21) Appl. No.: 13/159,759

(22) Filed: Jun. 14, 2011

(51) Int. Cl. G06F 15/18; G06N 5/04

(52) U.S. Cl. 706/12; 706/52

(57) ABSTRACT

Disclosed is a system and method for predicting political instability. This instability is predicted for specific countries or geographic regions. In one embodiment, the prediction is carried out on a basis of a probabilistic model, such as a Bayesian-network. The model is comprised of various notes corresponding to dependent and independent variables. The independent variables, in turn, correspond to factors relating to historical political instability. The dependent variable corresponds to the prediction of instability. By populating the independent variables with current data, future political instability can be predicted.

### TECHNICAL FIELD

This disclosure relates to a method for predicting the occurrence of political instability. More specifically, the disclosure relates to a system and method for predicting political instability using a Bayesian-network.

### BACKGROUND OF THE INVENTION

Regime change, ethnic war, genocide, politicide, and revolutionary war have occurred and reoccurred throughout the course of human history. Political conflicts such as these are destined to continue for the foreseeable future. Political instability results in the serious disruption of the social order and is often also accompanied by the loss of property and human life.

Governments and business alike would benefit from a greater understanding of why such political instability occurs. By understanding the underlying factors, political instability can be anticipated and predicted. Governments could benefit by anticipating political instability so that governmental interests can be protected and so that the consequences of such instability can be lessened. Businesses would likewise benefit by concentrating assets and investments in regions with higher degrees of political stability.

There are many economic, political and cultural factors that determine a country's political stability. The importance of these factors and the degree to which they affect the likelihood of conflict depends upon the region in the world and the historical time period. Several solutions have been proposed for the prediction of a country's stability. These solutions differ in the selection and definition of the factors used as well as the mathematical operations used upon the factors to result in a prediction of instability at some future time.

It is known in the prior art to use Bayesian networks in predictive models. For instance, Bayesian networks have been applied to predict the decision-making of political figures. Such systems model and predict a key figure's personality along with situational variables to determine what the leader is most likely to do in identified circumstances. One such system is outlined in Sticha, P. Buede D. and Rees, R. (2005) APOLLO: An Analytical Tool for Predicting a Subject's Decision Making, Preceedings of the 2005 International Conference on Intelligence Analysis, McLean Va.

Political instability modeling has also been done via logistic regression. An example of this is Goldstone et al. at the Political Instability Task Force (PITF). This method of modeling political instability uses logistic regression arrive at a stability prediction. Although logistic regression is simple, it lacks flexibility.

It is also known to model the behavior of ethno-national groups, rather than political instability. This work is being carried out at the University of Maryland and is used to predict social events. This is embodied in a complete Cultural Reasoning Architecture (CARA) and includes text mining (T-Rex: The RDF Extractor), data analysis (Oasys: Opinion Analysis System), and rule extraction (SOMA: Stochastic Opponent Modeling Agents) for predicting social unrest.

Despite the foregoing, there exists a need in the art for a comprehensive and flexible model for predicting political instability. There is also a need in the art for a model for predicting political instability that relies upon a probabilistic model, such as a Bayesian-network.

### SUMMARY OF THE INVENTION

The disclosed system has several important advantages. For example, the method permits users to more effectively predict political instability in various countries around the world.

A further possible advantage of the disclosed system is the creation of a Bayesian-network for use in predicting political instability.

Yet another possible advantage is the use of a variety of factors that are related to political instability and the use of a probabilistic model to relate the various factors.

Another advantage of the disclosed system is the ability to use computer modeling to sift through and relate large amounts of data.

It is also an advantage of the disclosed method to graphically display a Bayesian-network wherein a variety of independent variables are related to a dependent variable.

These and other advantages are achieved by providing a system and method for predicting internal conflict in a specific country or region. The prediction is based upon multiple factors that characterize the country's or region's social, economic, and political situation. Both the conflict and the factors are defined as discrete variables with two or more states. The values of the variables represent the factors and produce as the output the probability of the internal conflict occurring in the future.

Various embodiments of the invention may have none, some, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a flow chart illustrating a method carried out in accordance with the present disclosure;

FIG. 2 is a diagram of a Bayesian-network created in accordance with the present disclosure.

FIG. 3 is a diagram of a Bayesian-network created in accordance with the present disclosure.

FIG. 4 is a diagram of a Bayesian-network created in accordance with the present disclosure.

Similar reference characters refer to similar parts throughout the several views of the drawings.

### DETAILED DESCRIPTION OF THE DRAWINGS

The present invention relates to a system and method for predicting political instability. This instability is predicted for specific countries or geographic regions. In one embodiment, the prediction is carried out on a basis of a probabilistic model, such as a Bayesian-network. The model is comprised of various nodes corresponding to dependent and independent variables. The independent variables, in turn, correspond to factors relating to historical political instability. The dependent variable corresponds to the prediction of instability. By populating the independent variables with current data, future political instability can be predicted.

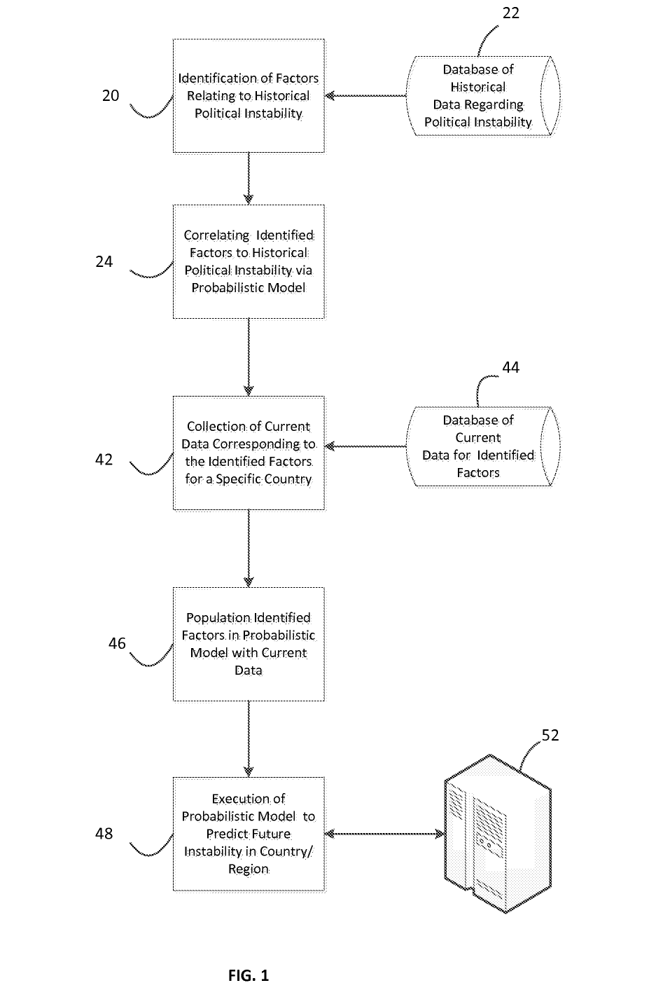

With reference now to FIG. 1, the steps used in carrying out the method of the present disclosure are illustrated. In the first step 20, a number of factors are identified that relate to instances of historical political instability. Multiple factors can be identified to characterize political unrest in a country or geographic region. Different factors can, of course, be used in different geographic regions or for different countries.

A number of public domain sources can be utilized to select the factors underlying political instability. This data can be derived from sources such as the Center for International Development and Conflict Management (CIDCM); the Political Instability Task Force (PITF) (Goldstone, PITF); the Minorities at Risk Organizational Behavior (MAROB); or the Uppsala Database of Internal Conflicts (UCDB). These publicly available sources provide knowledge about economic, political, and social factors that are relevant to the prediction of internal conflict within a country. These sources and the identified factors can be stored in database 22 for reference.

In one embodiment, a total of seven factors are related to political instability: 1) regime type; 2) infant mortality; 3) trade openness; 4) militarization; 5) neighbors at war; 6) political discrimination; and 7) the number of ethnic groups. This list, however, is not exhaustive; nor are all seven factors necessary. The specific factors used, and the number needed, will vary. It is envisioned that the factors will vary for different geographic regions. Nonetheless, the seven factors outlined above represent the key factors used by the system. Each of the seven factors is described in greater detail below.

### Regime Type

The regime type parameter describes the type of governing authority present within an individual country. Data for this variable can be obtained from the Political Instability Task Force (PITF) (Goldstone, PITF). This independent variable can have a number of states, depending upon the manner in which the regimes are characterized. In the case of PITF, the regimes are broken down into the following six categories: full democracy; partial democracy with factionalism; partial democracy without factionalism; partial autocracy; autocracy; or indeterminate. Thus, this variable can have one of six states depending upon the type of regime present within the country.

### Infant Mortality

Another variable is infant mortality. This variable quantifies the current year's infant mortality within a specified country. Data for infant mortality can be obtained from the Center for International Development and Conflict Management (CIDCM). It can be normalized to eliminate fluctuations over time. The normalized values can be quantified into a number of categories or states. These states include Low (0-0.838942); Medium (0.838942-1.07933); High (1.07933-1.23558); or Highest (more than 1.23588). Each of these values represents infant deaths per 100,000 births.

### Trade Openness

Trade Openness is a variable that indicates what proportion of the country's GDP is accounted for by imports and exports. Data for trade openness can be obtained from the Center for International Development and Conflict Management (CIDCM). Four categories are as follows: Low (0-1.3285); Medium (1.3285-2.41546); High (2.41546-3.91304); Highest (more than 3.91304). As explained by CIDCM, the values represent total imports divided by total exports.

### Militarization

The next variable or factor is militarization. This variable indicates what percentage of the country's population is involved in the active armed forces of the country or region. Again, the value comes from the Center for International Development and Conflict Management (CIDCM). It is quantified into one of the following states: Low (0-0.00317); Medium (0.00317-0.00886); High (0.00886-0.01784); Highest (more than 0.01784). In each of these, the value indicates the percentage of the total population that is in the active military.

### Neighbors at War

The next factor is neighbors at war, which is a binary variable indicating whether a defined number of neighbor countries are experiencing internal conflict. This value comes from the Political Instability Task Force (PITF) (Goldstone, PITF). This variable has two states. Yes indicates that four or more neighbors are experiencing internal conflict. No indicates that less than four neighbors are experiencing internal conflict.

### Political Discrimination

Political discrimination is a variable indicating the level of discrimination, if any, experienced by ethnic minorities or minority groups within the country or region. It comes from the Minorities at Risk Organizational Behavior (MAROB). The variable has the following states: zero; one; two; three; four or higher. These values indicate the number of ethnic groups that are experiencing discrimination.

### Economic Discrimination

Economic discrimination is a variable indicating the level of economic discrepancy, if any, experienced by ethnic or minority groups in a country. It comes from the Minorities at Risk Organizational Behavior (MAROB). The variable has five states: zero; one; two; three; four or higher. Again, these numbers correspond to the number of ethnic groups experiencing economic discrepancies within the country or region.

### Number of Ethnic Groups

Yet another factor is the number of ethnic groups within the country. The values for this variable come from the Minorities at Risk Organizational Behavior (MAROB). The variable represents the number of significant ethnic or minority groups in the country. The variable has five states: Small (0-2 groups); Medium (2-4 groups); High (4-6 groups); Very High (6 or more groups).

### Sub-Saharan Africa

The factors identified above are not exhaustive of all the factors that can be used to predict political instability. For certain geographic regions of the world, additional data will be both relevant and available. One such region is Sub-Saharan Africa. Here, three additional factors can be used. These factors include: 1) what is the country's former colonial power; 2) the present leader's term in office; and 3) the presence of a dominant religion.

The first additional variable specifies whether the country is a former colony of France or other colonial power. It has been determined that a country's previous colonial power is a predictor of future instability. The former colonial power variable has only two states: yes, meaning the country is a former colony of France; or no, meaning that the country is a former colony of another colonial power. Data for this variable can be obtained from the Political Instability Task Force (PITF) (Goldstone, PITF).

The other factor unique to countries in Sub-Saharan Africa is the present leader's term in office. This variable specifies how long the country's current leader has held power. This factor has three states: Long (over 8 years); Medium (3-8 years); or Short (less than 3 years). Data for this variable is likewise obtained from the Political Instability Task Force (PITF) (Goldstone, PITF).

The final unique factor for countries in Sub-Saharan Africa reflects the presence of a dominant religion. This variable has only two states and specifies whether there is a religion that is widely practiced within the country. Data for this variable is again obtained from the Political Instability Task Force (PITF) (Goldstone, PITF). The two states of the variable are: present, meaning that a dominant religion is practiced by at least 66% of the population; or absent, meaning that below 66% of the population practices a dominant religion.

Different models can be generated for other geographic regions to reflect differing factors. These other models can use any number of the above identified factors. Still yet other models can be developed that use factors beyond those identified above. The difference is a result of the fact that not all countries will have the same amount of data available due to interruptions in governance and/or transitions or wars. Additionally, the social, economic, demographic factors underlying political instability will vary among different geographic regions.

The present inventors have identified at least six regions in the world for which separate models, with differing factors, can be developed. The countries within these regions have relatively consistent social, economic, and demographic profiles such that a single probabilistic model can be used to predict political instability within any of the countries within the region. The six identified regions include: 1) Asia and the Pacific; 2) Eastern Europe and the former Soviet Union; 3) Latin America; 4) North Africa and the Middle East; 5) Sub-Saharan Africa; and 6) Western democracies and Japan.

Whatever model is developed, the factors are correlated to historical periods' of political instability at step 24. Any of the above identified sources, e.g. PITF, MAROB, or CIDCM, can be used to ascertain periods of internal conflict and the relevant time periods. For the purposes of this disclosure, internal conflict predicted by the present method is defined as one of the following: 1) adverse regime change; 2) ethnic wars; 3) genocide and politicide; or 4) revolutionary war.

A range of values can be associated with the historical occurrences of any of the internal conflict types. For instance, adverse regime change can have a range of 1 to 4; ethnic wars can have a value of 0 to 4; genocide and politicide can have a range of 0 to 5; and revolutionary war can have a range of 0 to 4. These values are assigned based upon the historical severity of the internal conflict, with more intense conflicts being assigned greater values. An average of all these values can then be computed to determine the presence of internal conflict. For example, an internal conflict will be deemed to have occurred if the average value is greater than or equal to 1.5. Conversely, an internal conflict will be deemed absent if the average value is less than 1.5.

A probabilistic model is further specified at step 24 whereby the identified factors are related to future political instability. Conditional probability tables are used in the model to relate individual factors to the odds of an internal conflict occurring in the future. An example of one such probability table is included below in Table 1. Similar tables are generated for each of the factors in the model. Together the models represent a probabilistic model for predicting future instability for a specific country or region.

TABLE 1
Conditional Probability Table for Infant Mortality Node

| | Onset of Conflict | Onset of |
|---|---|---|
| | Present | Conflict Absent |
| Low Infant Mortality | 0.0049019608 | 0.3519905 |
| Medium Infant Morality | 0.35784314 | 0.37189055 |
| High Infant Mortality | 0.55392157 | 0.076699834 |
| Highest Infant Mortality | 0.08333333 | 0.19941957 |

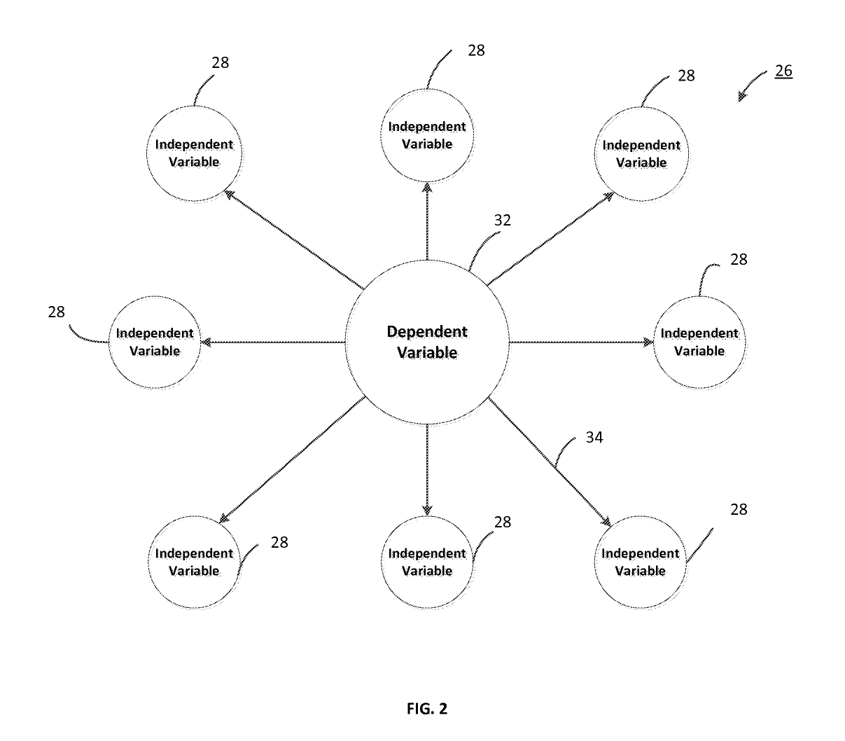

This form of probabilistic model is called a naive Bayesian-network 26. In a Bayesian-network (BN) the identified factors play the role of independent variables. These independent variables 28 are then related to the dependent variable 32 of political instability by means of edges. As illustrated in FIG. 2, the Bayesian-network model 26 can be graphically displayed in the form of nodes (28, 32) that are interconnected by relationship edges 34. Nodes (28, 32) represent both independent and dependent variables. Here, the independent variables 38 are the factors used in the model and the dependent variable 32 represents the presence or absence of internal conflict.

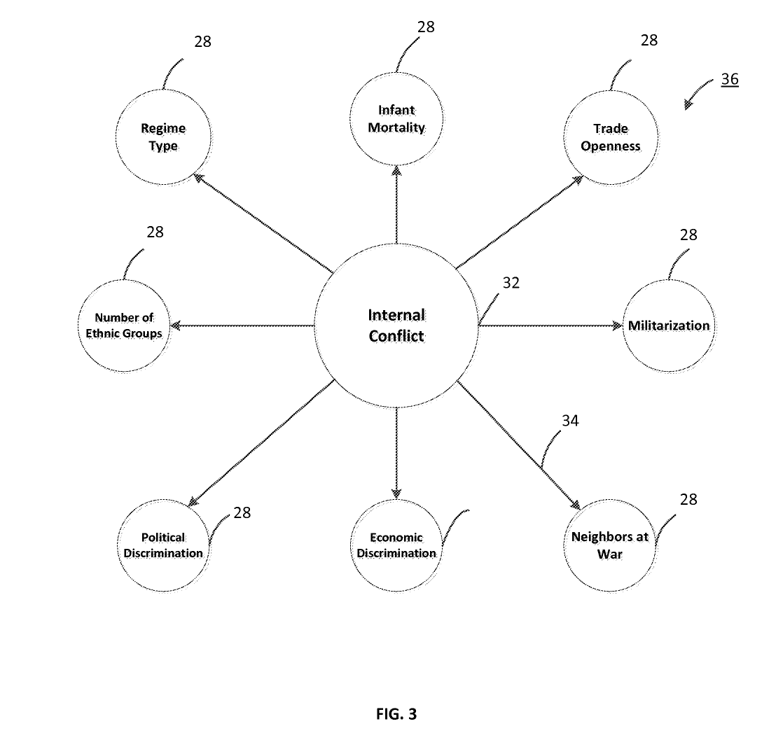

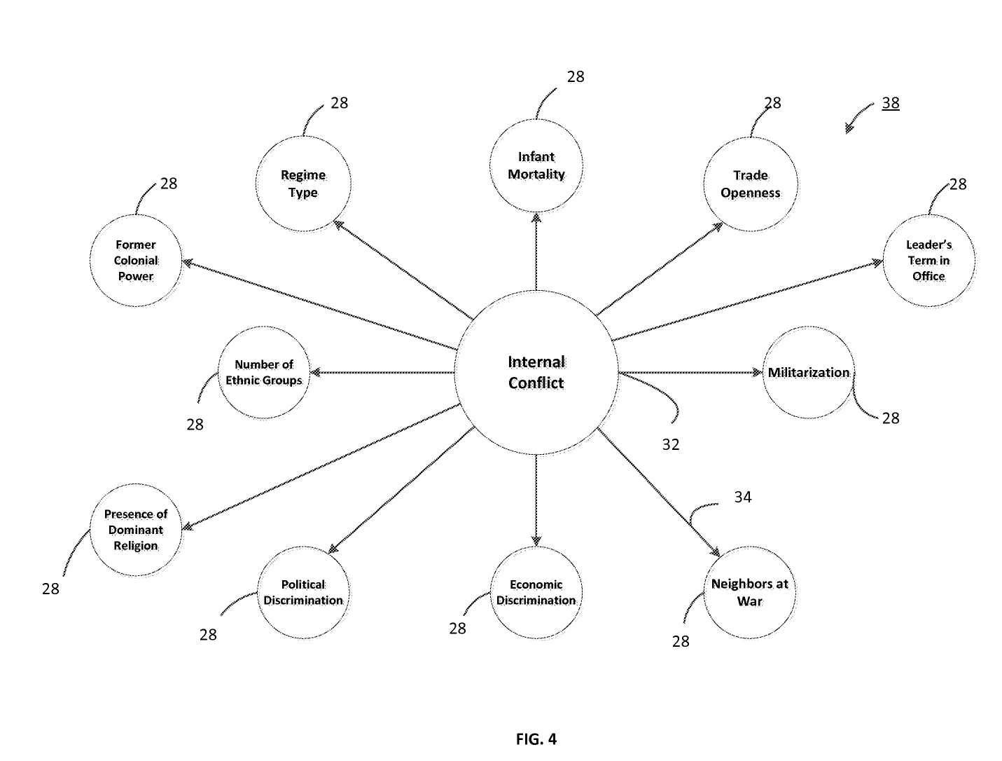

FIG. 3 is a graphic depiction of one possible Bayesian-network 36 wherein 8 different factors are related to the dependent variable internal conflict 32. FIG. 4 is a graphic depiction of another Bayesian-network 38 wherein 11 different factors are related to the internal conflict variable 32. In each instance, a conditional probability table specifies the relationship between each independent variable 28 and the internal conflict variable 32. In this manner, a model is generated whereby the different states of the variables are accorded different weights in assessing the probability of a future internal conflict.

The dependent variable of internal conflict has two states: onset of conflict present and onset of conflict absent. The positive state indicates that an internal conflict, as defined above, will occur within a succeeding two-year period. The negative state of the variable indicates that an internal conflict will not take place within the succeeding two-years period. We derive conditional probability tables of the BN separately for each of the six world regions. Thus, we create six BN each customized to its region. The parameters are obtained by means of learning from data. The learning algorithm is an Expectation Maximization (EM) algorithm [Hogg] and can be implemented using a built-in function of off-the-shelf tool, such as GeNIE.

The data sets for learning can be obtained from a variety of existing databases, such as CIDCM, PITF, MAROB, or the Base of International Conflicts (UCDP). The databases are organized by country and year and contain more fields than what are used for our Internal Conflict prediction. To create the records for BN parameter learning the data from the databases are extracted and processed. The following preprocessing and extraction steps are preformed on the raw data for each country and year:
1. Compute the state value of the dependent variable—Internal Conflict;
2. Compute the state values of all the independent variables;
3. Ignore all the year-country records, for which one or more independent or dependent variables cannot be computed, because of missing data;
4. Ignore all the year-country records, for which an external conflict is present (see Uppsala Data Base), [ucdp];
5. Ignore all the year-country records, which represent transition after internal conflict, i.e. five consecutive years for a given country after the end of the internal conflict
   After the preprocessing and extraction a record set is obtained with one record for each “allowed” year-country. Each record consists of the state-values for the dependent variable and all the independent variables.

As illustrated in FIG. 1, in next step 42, current data is collected corresponding to the factors representing the independent variables 28 for a specific model. This current data (i.e. not historical data) can be stored in database 44 and is used to set the values of the independent variables 28 for the model of a specific country or geographic region. This occurs at step 46. In the final step 48, the model is executed by way of a reasoner 52 to determine the value of the dependent variable 32. The built-in function of an off-the-shelf tool such as GeNIE can also be used. This value, in turn, is used to predict internal instability within a country or region within the next two years.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method for predicting political instability for a specific country within a geographic region, the method comprising the following steps:
identifying factors relating to historical political instability for countries within the geographic region, the historical political instability taking the form of historical data, the identified factors comprising regime type, infant mortality, trade openness, militarization, warfare in adjacent countries, political discrimination, economic discrimination, and the number of ethnic groups;
developing a structure of a naive Bayesian-network including independent variables and a dependent variable, the independent variables representing the identified factors and the dependent variable representing predicted political instability, the independent variables being connected by directed edges to the dependent variable at which the edges originate;
deriving conditional probability tables relating the identified factors to the historical political instability, the derivation learning from the historical data by using an expectation maximization algorithm;
collecting current data corresponding to the identified factors for the specific country;
setting the state of the independent variables of the Bayesian-network using the collected data;
executing the Bayesian-network to determine a value of the dependent variable and thereby predict political instability within the specific country.

2. A method for predicting instability for a country comprising:
identifying factors relating to historical instability for the country;
developing a probabilistic model relating the identified factors to prior periods of instability, the model including independent and dependent variables;
collecting current data corresponding to the identified factors for the country;
setting the state of the independent variables of the probabilistic model with the collected data.

3. The method as described in claim 2 comprising the further step of executing the probabilistic model to determine a value of the dependent variable.

4. The method as described in claim 2 wherein the probabilistic model is a series of conditional probability tables relating the identified factors to the historical political instability.

5. The method as described in claim 2 wherein at least one of following factors is developed: regime type, infant mortality, trade openness, militarization, warfare in adjacent countries, political discrimination, economic discrimination, and the number of ethnic groups.

6. The method as described in claim 2 comprising the further step of referencing publicly available sources to identify factors relating to historical instability for the country.

7. The method as described in claim 2 wherein any of the following are deemed to constitute an instability: 1) adverse regime change; 2) ethnic wars; 3) genocide and politicide; and 4) revolutionary war.

8. The method as described in claim 2 wherein at least one of following factors is developed: 1) whether the country is a former colonial power; 2) the present leader's term in office; and 3) the presence of a dominant religion.

9. The method as described in claim 2 comprising the future step of referencing publicly available sources to collect current data corresponding to the identified factors for the country.

10. The method as described in claim 2 wherein the identified factors relate to historical instability for a geographic region.

11. A system for predicting instability within a country, the prediction being based upon a probabilistic model for a geographic region, the system comprising:
a reasoning engine for storing and executing the probabilistic model, the probabilistic model relating a number of identified factors to future instability;
a database of current data corresponding to the identified factors;
whereby the reasoning engine can execute the probabilistic model with data from the database and thereby predict future instability.

12. The system as described in claim 11 wherein the probabilistic model is a Bayesian-network.

13. The system as described in claim 11 wherein the database is populated with data from publicly available sources.

14. The system as described in claim 11 wherein the identified factors include one or more of the following: regime type, infant mortality, trade openness, militarization, warfare in adjacent countries, political discrimination, economic discrimination, and the number of ethnic groups.

15. The system as described in claim 11 wherein the reasoning engine predicts one or more of the following: 1) adverse regime change; 2) ethnic wars; 3) genocide and politicide; and 4) revolutionary war.

16. The system as described in claim 11 wherein the identified factors include one or more of the following: 1) whether the country is a former colonial power; 2) the present leader's term in office; and 3) the presence of a dominant religion.

17. The system as described in claim 11 wherein the probabilistic model is developed with reference to publicly available sources.

18. The system as described in claim 11 wherein the probabilistic model is embodied in a series of conditional probability tables.

19. The system as described in claim 11 wherein the reasoning engine is a computer server.

20. The system as described in claim 11 wherein different probabilistic models are developed for different geographic regions in the world.
